(19) United States
(12) Patent Application Publication
(10) Pub. No.: US 2016/0198373 A1
(43) Pub. Date: Jul. 7, 2016

(54) Mobility Enhancement in Heterogeneous Networks

(71) Applicant: Telefonaktiebolaget L M Ericsson (publ), Stockholm (SE)

(72) Inventors: Santhan Thangarasa, Vallingby (SE); Muhammad Kazmi, Bromma (SE)

(21) Appl. No.: 14/903,301

(22) PCT Filed: Jul. 16, 2013
(86) PCT No.: PCT/IB2013/055852

§ 371 Date: Jan. 7, 2016

(51) Int. Cl. H04W 36/04; H04W 36/00; H04W 24/10

(52) U.S. Cl. CPC H04W 36/04; H04W 24/10; H04W 36/0088

(57) ABSTRACT

A method (100) for controlling a cell change of a wireless terminal (22) between a first cell (12) served by a LPN (14) and a second cell (16) served by a HPN (18) is disclosed. The cell change is delayed when one or more predefined conditions are met. The predefined conditions may be indicative of a receiver type in the wireless terminal (22), LPN (14), HPN (18), or a combination thereof. The delaying comprises delaying transmission of a cell change command to the wireless terminal (22) by at least a defined delay time relative to a time at which a measurement report is received from the wireless terminal (22); and/or configuring the wireless terminal (22) with at least one mobility parameter to cause a delay at the wireless terminal (22) in transmitting a measurement report relative to a time at which the wireless terminal (22) would have transmitted the measurement report without being configured with the at least one mobility parameter.

### TECHNICAL FIELD

This disclosure relates to handling mobility of wireless terminals in a Heterogeneous Network (HetNet), and more particularly to selectively delaying a cell change of a wireless terminal between a first cell served by a low power node and a second cell served by a high power node in a HetNet based on one or more predefined conditions.

### BACKGROUND

Heterogeneous Networks (“HetNets”) overlay a homogeneous network layer of macro cells served by high power nodes (HPNs), such as wide area base station, with additional non-macro cells served by low power nodes (LPNs), such as pico, micro and femto base stations which are also interchangeably called local area base stations, medium range base stations and home base stations respectively. The different types of base stations differ at least in terms of their maximum output power as shown in Table 1. The most simplified heterogeneous network is 2-tier system which includes at least two layers (e.g., a set of macro and pico base stations). The homogeneous layer of macro cells is known as a “macro” layer, as the base stations in this layer have large coverage areas. The non-homogenous layer contains LPNs, such as pico, micro and femto base stations, which support smaller cells. HetNets are expected to offer a low cost alternative to simply adding more high power base stations, and are expected to be effective, as the deployment of LPNs can be focused towards hot spots and areas with coverage problems.

Mobility is an important aspect of wireless communication networks, and refers to the ability of a wireless terminal to change cells in the network. For example, handover is used to try to provide service continuity for a wireless terminal (e.g., a User Equipment or “UE”) by transferring a connection from one cell to another cell depending on several factors such as signal strength, load conditions, service requirements, etc. The provision of efficient and effective handovers (e.g., minimum number of unnecessary handovers, minimum number of handover failures, etc.), affects not only the Quality of Service (QoS) of the end user but also the overall network capacity and performance.

Notably though, existing mobility methods are optimized for homogeneous networks, not HetNets. LPNs have lower output power and a smaller downlink coverage area as compared to HPNs. Thus, the coverage of a cell served by the LPN decreases much more quickly as a wireless terminal is moving away from the LPN to a HPN than is the case when a wireless terminal moves from a HPN to a LPN. This may cause a cell change command (e.g., handover command) transmitted by a LPN to be lost.

Also, cell change of a wireless terminal from a cell served by a HPN to a cell served by a LPN is problematic since the pilot signals transmitted from the LPN can overwhelm the control signaling transmitted by the serving cell of the HPN. This deteriorates the reception of signaling at the UE served by the HPN, and can lead to loss of cell change commands. In this case, even transmission to the LPN acts as an aggressor to the victim wireless terminal served by the HPN. This in turn also leads to an increased handover failure rate. The situation becomes worse for high speed users.

### SUMMARY

According to one aspect of the present disclosure, a method is implemented by a network node for controlling a cell change of a wireless terminal from a first cell served by a low power node (LPN) to a second cell served by a high power node (HPN), wherein the LPN has a lower output power than the HPN. The cell change of the wireless terminal is delayed when at least one of one or more predefined conditions are met, the one or more predefined conditions comprising one or more of:
the LPN having a maximum rated output power that exceeds a predefined threshold;
the wireless terminal having a type of receiver that can mitigate at least external interference caused by signals received from at least one neighbor cell of the first cell; and
the wireless terminal having multiple receive antennas.

The delaying comprises one or more of:
delaying transmission of a call change command to the wireless terminal by at least a defined delay time relative to a time at which a measurement report is received from the wireless terminal; and
configuring the wireless terminal with at least one mobility parameter to cause a delay at the wireless terminal in transmitting a measurement report relative to a time at which the wireless terminal would have transmitted the measurement report without being configured with the at least one mobility parameter.

According to one aspect of the present disclosure, a complementary network node is operative to delay a cell change of a wireless terminal from a first cell served by a LPN to a second cell served by a HPN, wherein the LPN has a lower output power than the HPN. The network node includes one or more processing circuits configured to delay the cell change of the wireless terminal when at least one of one or more predefined conditions are met, the one or more predefined conditions comprising one or more of:
the LPN having a maximum rated output power that exceeds a predefined threshold;
the wireless terminal having a type of receiver that can mitigate at least external interference caused by signals received from at least one neighbor cell of the first cell; and
the wireless terminal having multiple receive antennas.

To delay the cell change of the wireless terminal, the one or more processing circuits are configured to:
delay transmission of a cell change command to the wireless terminal by at least a defined delay time relative to a time at which a measurement report is received from the wireless terminal; and/or
configure the wireless terminal with at least one mobility parameter to cause a delay at the wireless terminal in transmitting a measurement report relative to a time at which the wireless terminal would have transmitted the measurement report without being configured with the at least one mobility parameter.

In one or more embodiments of the method or apparatus described above, the predefined conditions further comprise one or more of the HPN having a type of receiver that can mitigate at least external interference caused by signals received from at least one wireless terminal not served by the HPN, and the HPN having multiple receive antennas.

According to another aspect of the present disclosure, a method is implemented by a network node for controlling a cell change of a wireless terminal from a second cell served by a HPN to a first cell served by a LPN, wherein the HPN has a higher output power than the LPN. The cell change of the wireless terminal is delayed when at least one of one or more predefined conditions are met, the one or more predefined conditions comprising one or more of.
the wireless terminal having a type of receiver that can mitigate at least external interference caused by signals received from at least one neighbor cell of the second cell, having multiple receive antennas, or both; and
the LPN having a type of receiver that can mitigate at least external interference caused by signals received from at least one wireless terminal not served by the LPN, having multiple receive antennas, or both.

The delaying comprises one or more of:
delaying transmission of a cell change command to the wireless terminal by at least a defined delay time relative to a time at which a measurement report is received from the wireless terminal; and
configuring the wireless terminal with at least one mobility parameter to cause a delay at the wireless terminal in transmitting a measurement report relative to a time at which the wireless terminal would have transmitted the measurement report without being configured with the at least one mobility parameter.

According to one aspect of the present disclosure, a complementary network node is operative to delay a cell change of a wireless terminal from a second cell served by a HPN to a first cell served by a LPN, wherein the LPN has a lower output power than the HPN. The network node includes one or more processing circuits configured to delay the cell change of the wireless terminal when at least one of one or more predefined conditions are met, the one or more predefined conditions comprising one or more of:
the wireless terminal having a type of receiver that can mitigate at least external interference caused by signals received from at least one neighbor cell of the second cell, having multiple receive antennas, or both; and
the LPN having a type of receiver that can mitigate at least external interference caused by signals received from at least one wireless terminal not served by the LPN, having multiple receive antennas, or both.

To delay the cell change of the wireless terminal, the one or more processing circuits are configured to:
delay transmission of a cell change command to the wireless terminal by at least a defined delay time relative to a time at which a measurement report is received from the wireless terminal; and/or
configure the wireless terminal with at least one mobility parameter to cause a delay at the wireless terminal in transmitting a measurement report relative to a time at which the wireless terminal would have transmitted the measurement report without being configured with the at least one mobility parameter.

Of course, the features discussed above are not limiting. Indeed, those skilled in the art will recognize additional features upon reading the following detailed description, and upon viewing the accompanying drawings.

### BRIEF DESCRIPTION OF THE DRAWINGS

FIG. 1 schematically illustrates an example wireless communication network including a first cell served by a low power node (LPN) and a second cell served by a high power node (HPN).

FIG. 2 is a flow chart of an example method for controlling a cell change of a wireless terminal between a first cell served by a LPN and a second cell served by a HPN.

FIG. 3 illustrates an example implementation of the method of FIG. 2.

FIG. 3a illustrates another example implementation of the method of FIG. 2.

FIG. 4 illustrates another example implementation of the method of FIG. 2.

FIG. 5 schematically illustrates an example network node.

### DETAILED DESCRIPTION

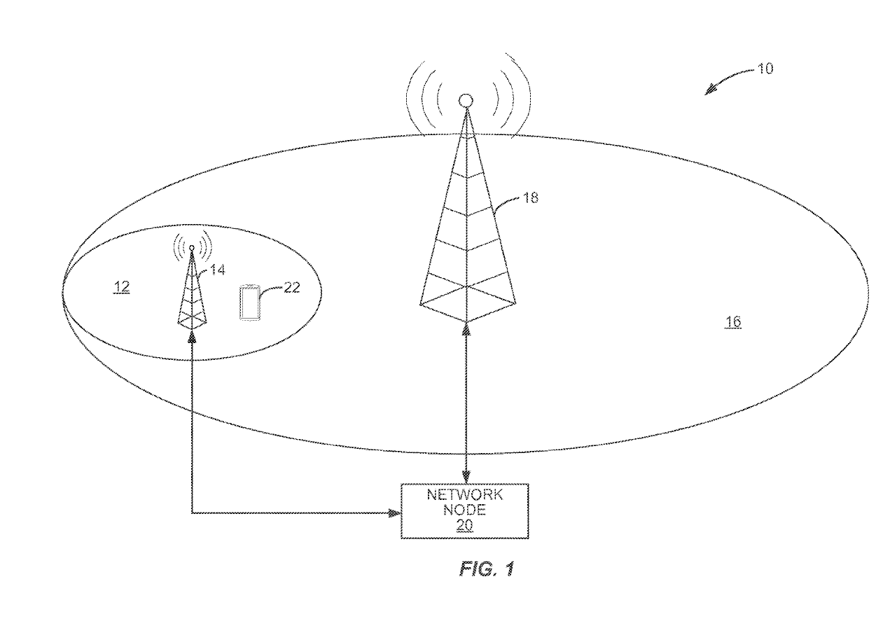

FIG. 1 schematically Illustrates an example wireless communication network 10 including a first cell 12 served by a low power node (LPN) 14 and a second cell 16 served by a high power node (HPN) 18. Thus, the network 10 is a HetNet. A network node 20 is in communication with each of the LPN 14 and HPN 18. In one or more embodiments, the LPN 14 is one of a home base station, a local area base station and a medium base station, and the cell 12 is one of a femto cell, a pico cell, and a micro cell. In one or more embodiments, the HPN 18 is a NodeB or eNodeB, and the cell 16 is a macro cell. In one or more embodiments the network node 20 is a radio network controller (RNC), base station controller (BSC), relay, or donor node controlling a relay.

Based on one or more predefined conditions being met, the LPN 14, HPN 18, or network node 20 is operative to delay a cell change of a wireless terminal 22 between the first cell 12 and the second cell 16 (i.e., from the first cell 12 to the second cell 16, or from the second cell 16 to the first cell 12). The wireless terminal 22 may be a cellular telephone, smartphone, personal digital assistant (PDA), tablet computer, laptop computer, laptop embedded equipment (LEE), laptop mounted equipment (LME), USB dongle, or any other device equipped with wireless communication capabilities.

In one or more embodiments, delaying the cell change includes controlling the timing of transmitting a cell change command, and/or modifying a mobility parameter of the wireless terminal to affect when the wireless terminal transmits a measurement report used to trigger a cell change. The predefined conditions may be indicative of a receiver type in the wireless terminal 22, LPN 14, HPN 18, or a combination thereof. However, prior to discussing these cell change delay features in greater detail, an overview of wireless terminal radio measurements, wireless terminal mobility, and enhanced/advanced receivers will be provided.

Radio Measurements

The wireless terminal 22 takes measurements on its serving cell as well as on neighbor cells over some known reference symbols or pilot sequences. The measurements may be done on cells on an intra-frequency carrier, inter-frequency carrier(s), as well as on inter-RAT carriers(s) (with “RAT” referring to “Radio Access Technology), depending upon whether the wireless terminal 22 supports that RAT.

The wireless terminal 22 receives measurement configuration or assistance data/information, which is a message or an information element (IE) sent by a network node (e.g., serving base station, positioning node, etc.) to configure the wireless terminal 22 to perform the requested measurements. For example, the information may relate to carrier frequency, RATs, type of measurement (e.g., Reference Signal Received Power “RSRP”), higher layer time domain filtering, measurement bandwidth related parameters, etc.

Some measurements may also require the wireless terminal 22 to measure the signals transmitted by the wireless terminal 22 in the uplink. These measurements are done by the wireless terminal 22 in an active state (e.g., CELL_DCH state in High Speed Packet Access “HSPA”, Radio Resource Control “RRC” connected state in Long Term Evolution “LTE”, etc.) as well as in low activity RRC states (e.g., idle state, CELL_FACH state in HSPA. URA_PCH and CELL_PCH states in HSPA, or the RRC_IDLE state in LTE).

In multi-carrier or carrier aggregation (CA) scenarios, the wireless terminal 22 may perform measurements on the cells on the primary component carrier (PCC) as well as on the cells on one or more secondary component carriers (SCCs). The measurements are done for various purposes. Some example measurement purposes are: mobility, positioning, a self-organizing network (SON), minimization of drive tests (MDT), operation and maintenance (O&M), network planning and optimization, etc.

Mobility

In High Speed Packet Access (HSPA) and Long Term Evolution (LTE) networks, wireless terminal 22 mobility is performed in both active and low activity states. Handover in Wideband Code Division Multiple Access (WCDMA) networks is network-controlled based on measurement reports from the wireless terminal 22. A key feature in WCDMA handover is the concept of “soft handover.” This refers to multiple cells transmitting or receiving data from a single wireless terminal 22. With the introduction of HSPA/EUL (Enhanced Uplink), downlink soft handover was removed in exchange for higher data rates, but uplink soft handover is still present. The cells in which the wireless terminal 22 is in soft handover with are called an “active set.” Of the cells in the active set, the serving cell is responsible for downlink data transmission to the wireless terminal 22 and has the main control over the uplink.

As the wireless terminal 22 moves around in the network, cells will be added and removed from the active set and there can also be a serving cell change, such as a handover, where a new cell takes over the downlink data transmission and takes control over the uplink. There are a large number of measurements that the wireless terminal 22 can perform, which all result in a measurement report being sent to the network. Some reports are sent periodically (periodic reports), some are sent when a defined criteria is fulfilled (event-based reports), and some are sent periodically once a defined criteria is fulfilled (event-based periodic reports).

The basic procedure for network-controlled event-based handover has these steps. First the network informs the wireless terminal 22 about which events to use and which settings to use for the evaluation of the events. The network may even configure the wireless terminal with multiple events or the same event with different parameter settings. The event to use and the settings to use for evaluation of the event define the event criterion. When an event criterion is fulfilled by wireless terminal 22 measurements, a measurement report is sent from the wireless terminal 22 to the network. Based on the report the network decides what to do, and often the network will do as suggested in the report. The network prepares for the handover and sends a command to the wireless terminal 22. The wireless terminal 22 will respond by doing what is required in the command, and send a response back to the network.

Measurements in HSPA are performed by the wireless terminal on the common pilot channel (CPICH) and are based on either a

$$\frac{Ec}{No}$$

ratio of energy per modulating bit to the noise spectral density, or Received Signal Code Power (RSCP). The analogous measurements in LTE are Reference Signal Received Power (RSRP) and Reference Signal Received Quality (RSRQ) which are performed on reference signals which are analogous to the common pilot channel (CPICH) in HSPA. The CPICH RSCP or RSRP and CPICH Ec/No or RSRQ are more generally called “signal strength measurements” and “signal quality measurements,” respectively. Yet other examples of signal strength and signal quality radio measurements are path loss and signal to noise ratio (SNR) or signal to interference plus noise ratio (SINR), respectively.

Enhanced/Advanced Receivers

An enhanced receiver, which is often called an “advanced receiver,” can be used at a wireless terminal as well as at a radio network node (e.g., LPN 14, HPN 18, a relay, etc.) for improving the reception of received wanted radio signals. Such receivers are capable of mitigating external interference. For example, if the wireless terminal 22 included such a receiver it would be capable of mitigating at least external interference caused by signals received from at least one neighbor cell of its serving cell 12 or 16. Similarly, if the LPN 14 included such a receiver it would be capable of mitigating at least external interference caused by signals received from at least one wireless terminal not served by the LPN 14. If the HPN 18 included such a receiver, it would be capable of mitigating at least external interference caused by signals received from at least one wireless terminal 22 not served by the HPN 18.

The phrase “at least” is used here because there may be additional interference mitigation capabilities. For example, the wireless terminal 22 that is capable of mitigating at least external interference caused by signals received from a neighbor cell of its serving cell could also be capable of mitigating other interference—such as interference caused by its own uplink transmissions, and/or interference caused by other wireless terminals in the same cell as the wireless terminal 22.

A well-known example of an advanced receiver is a Minimum Mean Square Error Interference Rejection Combining (MMSE-IRC). An example of more sophisticated advanced receiver is Minimum Mean Square Error-turbo Interference Cancellation (MMSE-turbo IC), which is capable of performing non-linear subtractive-type interference cancellation. Such advanced receivers can be used to enhance system performance. Even use of multiple receive antennas at a receiver is a kind of an advanced receiver. Interference cancellation or suppression by such advanced receiver structures can lead to the elimination of interference, in which case the interference is completely cancelled, whereas in other cases the impact of interference on the useful signal is reduced.

An advanced receiver can be used for receiving one or more types of physical signals (e.g., pilots, CPICH, any reference or pilot signal in general, etc.) or physical channel (e.g., HS-DSCH, HS-SCCH, etc.).

According to various 3rd Generation Partnership Project (3GPP) standards, there exists various levels of enhanced receivers, such as “enhanced receiver type 1,” “enhanced receiver type 2,” etc. Each of these receiver types is capable of mitigating various degrees of external interference. Thus, an enhanced receiver type 2 is capable of mitigating more interference than an enhanced receiver type 2. An enhanced receiver type 3 is capable of mitigating even more interference than the type 2 receiver. In these standards a “baseline” receiver is one which lacks the ability to mitigate external interference.

Improved Cell Change Features

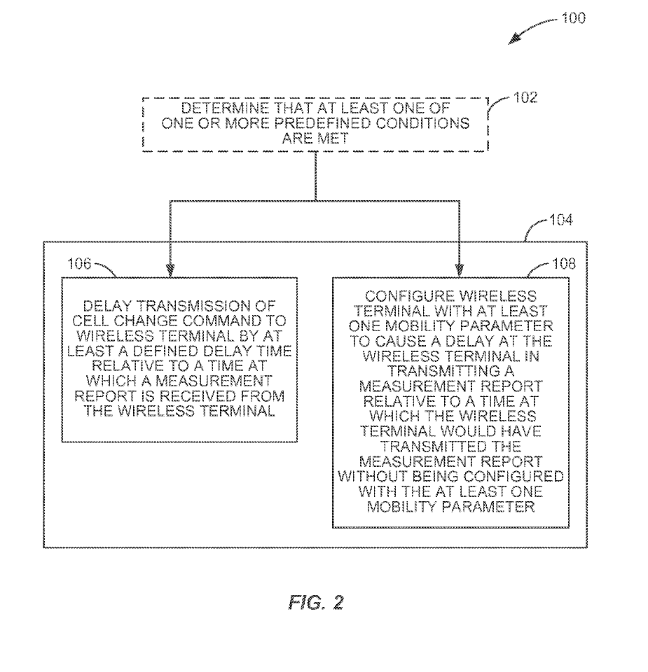

FIG. 2 is a flow chart of an example method 100 for controlling a cell change of a wireless terminal between a first cell 12 served by LPN 14 and second cell 16 served by HPN 18. The method 100 is implemented by the LPN 14, the HPN 18, or the network node 20. Thus, it is understood that references to “the network node implementing method 100” could refer to any of the LPN 14, HPN 18, and the network node 20.

An optional determination is made that at least one of one or more predefined conditions are met (block 102), and the cell change is then delayed (block 104). The optional nature of step 102 will be clarified below. The delaying 104 of the cell change comprises one or more of
delaying transmission (block 106) of a cell change command to the wireless terminal 22 by at least a defined delay time relative to a time at which a measurement report is received from the wireless terminal 22; and
configuring (block 108) the wireless terminal 22 with at least one mobility parameter to cause a delay at the wireless terminal 22 in transmitting a measurement report relative to a time at which the wireless terminal 22 would have transmitted the measurement report without being configured with the at least one mobility parameter.

The one or more predefined conditions are based on one or more of LPN 14 receiver type, HPN 18 receiver type, wireless terminal 22 receiver type, and LPN 14 maximum rated output power. Depending on whether the cell change is from the first cell 12 served by LPN 14 to the second cell 16 served by HPN 18, or is from the second cell 16 to the first cell 12, the predefined conditions may vary.

According to one embodiment, the method 100 is performed to control a cell change of the wireless terminal 22 from the first cell 12 served by LPN 14 to the second cell 16 served by HPN 18. In this embodiment, the predefined conditions include one or more of:
the LPN 14 having a maximum rated output power that exceeds a predefined threshold;
the wireless terminal 22 having a type of receiver that can mitigate at least external interference caused by signals received from at least one neighbor cell of the first cell 12; and
the wireless terminal 22 having multiple receive antennas.

As mentioned above, determining that at least one of the one or more predefined conditions are met (block 102) is in some embodiments an optional step. For predefined conditions such as the wireless terminal 22 having a type of receiver that can mitigate external interference, it is possible that the LPN 14 may encounter terminals having and lacking this feature, so the determining 102 is more likely to be necessary. However, for the predefined condition of the LPN 14 having a maximum rated output power that exceeds a predefined threshold, it is possible that this may always be true for the LPN 14 (e.g., the LPN 14 is configured this way prior to use), so it would be unnecessary for the determining to be performed for this predefined condition in such an instance. Nevertheless, in some instances it may be desirable to still perform the determining of block 102 for the LPN 14 maximum rated output power predefined condition, because, for example, the threshold to which the maximum LPN 14 output power is compared may be variable.

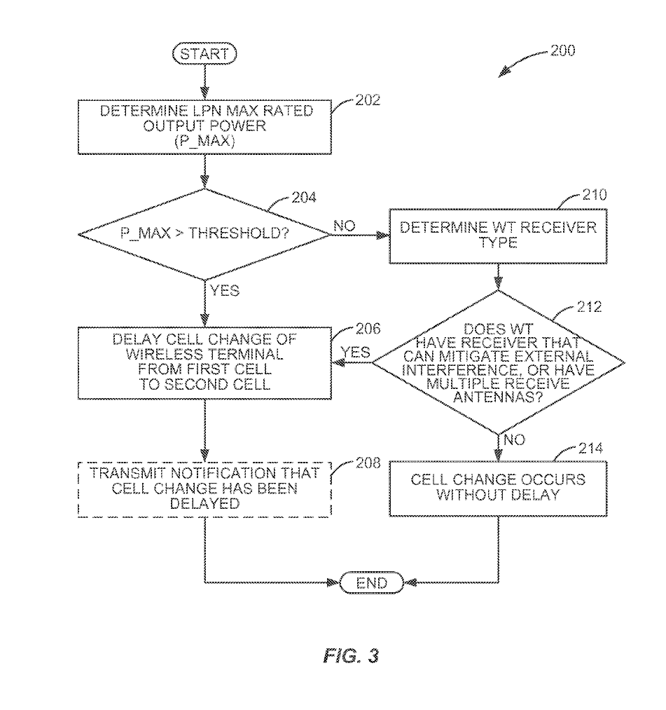

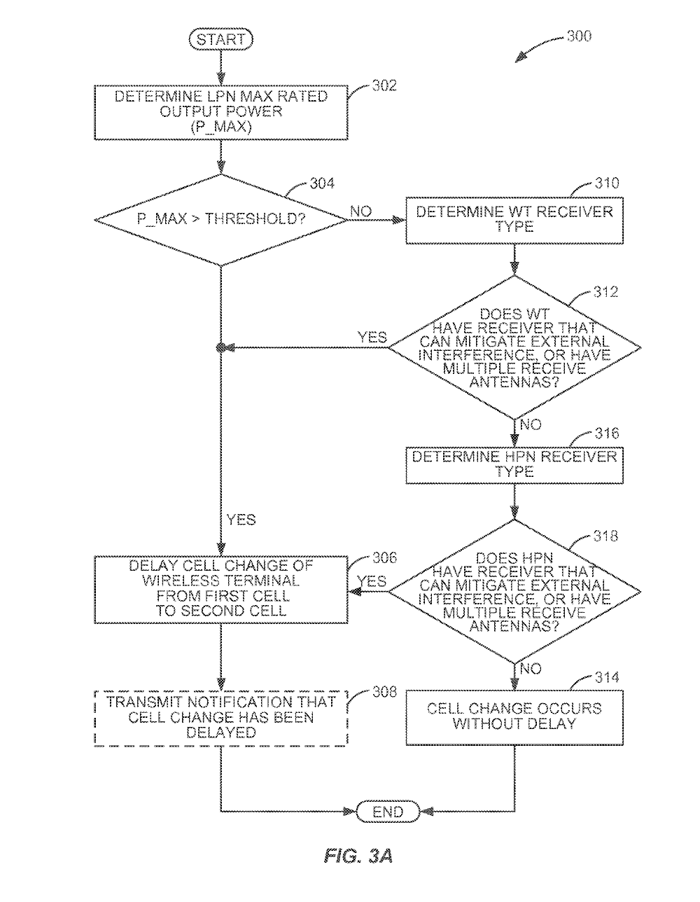

FIG. 3 illustrates an example implementation of the method 100 according to the embodiment discussed above in which a cell change from the first cell 12 served by LPN 14 to the second cell 16 served by HPN 18 is selectively delayed. As shown in FIG. 3, a determination is made of the maximum rated output power of the LPN 14 (P_{MAX}) (block 202) and that maximum rated output power is compared to a threshold (block 204). If P_{MAX} exceeds the threshold, then the cell change of the wireless terminal 22 from the first cell 12 to the second cell 16 is delayed (block 206).

Optionally, a notification may be transmitted (block 208) to indicate that the cell change has been delayed. The optional notification may be transmitted, e.g., to the wireless terminal 22, to another network node (e.g., HPN 18 or a Radio Network Controller “RNC”), or both, to indicate that the cell change of the wireless terminal 22 has been delayed. In one or more embodiments the wireless terminal 22 receives such a notification, and based on that notification activates its advanced receiver capabilities (e.g., its ability to mitigate external interference and/or to use multiple receive antennas). The notification may also indicate the strongest aggressor HPNs to allow the wireless terminal 22 to more effectively mitigate interference caused by those nodes.

If P_{MAX} does not exceed the threshold, then a receiver type of the wireless terminal 22 is determined (block 210), and a determination is made of whether the wireless terminal 22 has a receiver that can mitigate at least external interference caused by signals received from at least one neighbor cell of the first cell 12 and/or if the wireless terminal 22 has multiple receive antennas (block 212). If either of these conditions is true, then the cell change is delayed (block 206) and optionally a notification is transmitted (block 208). Otherwise, if neither of these conditions is true, then the cell change occurs without delay (block 214). In one embodiment, block 214 includes maintaining an existing mobility parameter at the wireless terminal 22, so that when the wireless terminal 22 submits measurement reports is not changed. In the same or another embodiment, block 214 includes transmitting a pending cell change command without delaying by a defined delay time relative to a time at which a measurement report is received from the wireless terminal 22.

In one or more embodiments, for a cell change from the first cell 12 to second cell 16, another predefined condition that can trigger the delay of block 206 is the HPN 18 having a type of receiver that can mitigate at least external interference caused by signals received from at least one wireless terminal not served by the HPN 18, and/or the HPN 18 having multiple receive antennas. This is illustrated in the flowchart 300 of FIG. 3a. Blocks 302-314 refer to the same actions as blocks 202-214 of FIG. 3. However, in the flowchart 300 the additional predefined condition of HPN 18 receiver type is analyzed as a predefined condition (see blocks 316-318).

Of course, it is understood that the predefined conditions could be analyzed in a different order than that shown in FIGS. 3 and 3a. For example, blocks 210, 212 could precede block 204 (such that if the wireless terminal 22 does have a receiver that can mitigate external interference then block 204 is never performed). Similarly, blocks 316-318 could precede blocks 310-312 and/or block 304.

Referring again to FIG. 2, according to another embodiment, the method 100 is performed to control a cell change of the wireless terminal 22 from the second cell 16 served by HPN 18 to the first cell 12 served by LPN 14. In this embodiment, the predefined conditions include one or more of:
the wireless terminal 22 having a type of receiver that can mitigate at least external interference caused by signals received from at least one neighbor cell of the second cell 16, having multiple receive antennas, or both; and
the LPN 14 having a type of receiver that can mitigate at least external interference caused by signals received from at least one wireless terminal 22 not served by the LPN 14, having multiple receive antennas, or both.

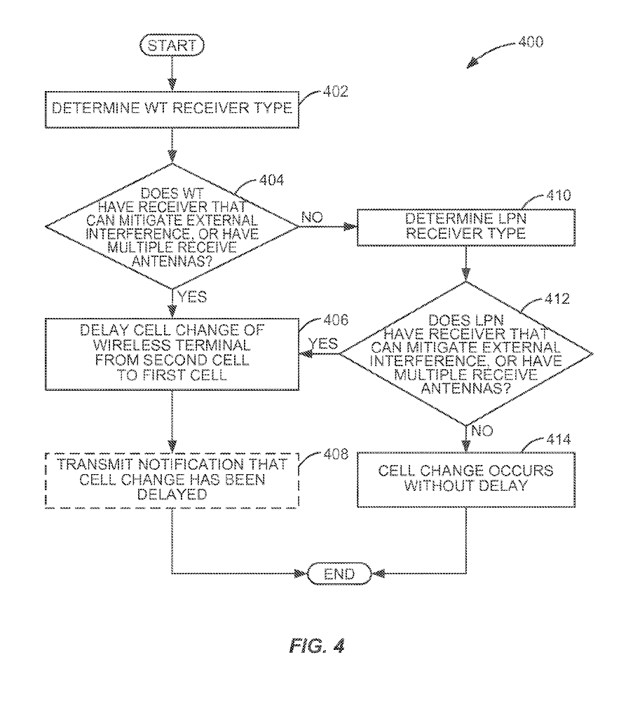

FIG. 4 illustrates an example implementation of this embodiment (i.e., cell change from second cell 16 to first cell 12) in the form of flowchart 400. As shown in FIG. 4, a receiver type of the wireless terminal 22 is determined (block 402), and a determination is made of whether the wireless terminal 22 has a type of receiver that can mitigate at least external interference caused by signals received from at least one neighbor cell of the second cell 16 and/or if the wireless terminal 22 has multiple receive antennas (block 404). If either of these conditions is true, then the cell change from the second cell 16 to the first cell 12 is delayed (block 406) and optionally a notification is transmitted (block 408). In one or more embodiments, the LPN 14 receives such a notification, and based on that notification activates its advanced receiver capabilities (e.g., the ability to mitigate external interference and/or the use of multiple receive antennas). Of course, these are only non-limiting examples of notifications. It is also possible that the wireless terminal 22 or some other network node could receive such a notification.

If the wireless terminal 22 does not have a receiver that can mitigate external interference and does not have multiple receive antennas, then the LPN receiver type is determined (block 410) and a determination is made as to whether the LPN 14 has a receiver that can mitigate at least external interference, and/or of whether the LPN 14 has multiple receive antennas (block 412). If either of these conditions is true, then the cell change from the second cell 16 to the first cell 12 is delayed (block 406) and optionally a notification is transmitted (block 408).

Otherwise the cell change occurs without delay (block 414). In one embodiment block 414 includes maintaining an existing mobility parameter at the wireless terminal 22, so that when the wireless terminal 22 submits measurement reports is not changed. In the same or another embodiment, block 414 includes transmitting a pending cell change command without delaying by a defined delay time relative to a time at which a measurement report is received from the wireless terminal 22.

In FIG. 4 (as with FIGS. 3 and 3a), it is understood that the predefined conditions could be analyzed in a different order. Thus, for example, blocks 410-412 could precede block 404.

Determination of Wireless Terminal Receiver Type

As discussed above, information regarding the wireless terminal 22 receiver type may be used when determining whether to delay a cell change of the wireless terminal 22. In particular, a determination is made of whether the wireless terminal 12 includes a type of receiver that can mitigate at least external interference caused by signals received from at least one neighbor cell of its serving cell 12 or 16, and/or if the wireless terminal 22 has multiple receive antennas. This information may be obtained based on an explicit indication, an implicit determination, or combination thereof.

Explicit Mechanism

In an explicit mechanism, the node performing the method 100 acquires explicit information from the wireless terminal 22 about its supported receiver types. In one example, the wireless terminal 22 sends a message (e.g., using RRC signaling) indicating that it supports “enhanced receiver type 1” (i.e., receiver diversity) for receiving one or more types of physical channels, such as the High-Speed Physical Downlink Shared Channel (HS-PDSCH), High Speed-Shared Control Channel (HS-SCCH), etc.

In another example, the wireless terminal 22 sends a message (e.g., using RRC signaling) indicating that it supports “enhanced receiver type 1” (i.e., receiver diversity) as well as “enhanced receiver type 2” (i.e., MMSE) for receiving one or more types of physical channels, such as the HS-PDSCH, HS-SCCH, Broadcast Channel (BCH), Paging Channel (PCH), etc.

Implicit Mechanism

In an implicit mechanism, the wireless terminal 22 receiver type can be autonomously determined based on a quality level of wireless terminal 22 radio measurements, and/or detection of the characteristics or pattern of wireless terminal 22 transmitted signals.

In one or more embodiments this includes comparing a radio measurement from the wireless terminal 22 to one or more of:
a radio measurement from an additional wireless terminal that is known to not have a type of receiver that can mitigate external interference and to not have multiple receive antennas; and
a reference radio measurement value representing a radio measurement performed by an additional wireless terminal which does not have a type of receiver that can mitigate external interference and does not have multiple receive antennas.

If the comparing indicates that the wireless terminal 22 is subject to less external interference than the additional wireless terminal, then the node performing method 100 determines that the wireless terminal 22 has a type of receiver that can mitigate external interference, has multiple receive antennas, or both. In one or more embodiments the compared radio measurements are downlink radio measurements.

Examples of wireless terminal 22 radio measurements include any of the following, for example:
Channel State Information (CSI) reports: such as Channel Quality Indicator (CQI), pre-coding indicator (PCI), rank indicator (RI), block error rate (BLER), SNR, and SINR;
signal strength information: such as Common Pilot Channel (CPICH) Reference Signal Received Power (RSRP), CPICH Received Signal Code Power (RSCP), and path loss; and
signal quality information: such as

$$C P I C H \frac{Ec}{No}$$

### and CPICH Reference Signal Received Quality (RSRQ).

Examples of wireless terminal 22 transmitted signals whose characteristics or pattern can be detected at the node implementing the method 100 (e.g., LPN 14, HPN 18, or network node 20) includes Hybrid Automatic Repeat Request (HARQ) feedback information (e.g., an ACK/NACK related to downlink reception sent by the wireless terminal 22).

In High Speed Packet Access (HSPA), the High Speed-Dedicated Physical Control Channel (HS-DPCCH) is used to transmit feedback regarding HS-PDSCH decoding (i.e., the received downlink data). For each received downlink transmission time interval (TTI) of each user, an ACK or NACK is sent on the uplink HS-DPCCH channel to indicate whether the downlink reception was successful or not. The HS-DPCCH is sent to the serving cell. In addition to HARQ messages, the HS-DPCCH channel is also used to transmit feedback regarding the channel quality, and to transmit CQI which is used for channel-dependent scheduling and rate control.

In particular in HSPA, the wireless terminal 22 receiver type can be autonomously detected by comparing the wireless terminal 22 reported CQI (“CQI_{Report}”) with a reference CQI (“CQI_{Ref}”) value under certain radio conditions. The reference CQI can correspond to the CQI reported by a wireless terminal 22 using a baseline receiver (i.e., one that does not have multiple receive antennas and that is not capable of mitigating external Interference caused by signals received from neighbor cells). Different enhanced or advanced receivers are capable of mitigating different level and/or type of interference Therefore the type of receiver of the wireless terminal 22 can be determined in terms of its interference mitigation capability by observing the difference between the wireless terminal 22 reported CQI and the reference CQI. The comparison can be based on a single reported CQI value, or it can be based on statistics to improve reliability of results.

Consider for example two different types of enhanced receivers: type A and type B. The receiver type B is capable of mitigating more interference compared to that by receiver A. Let us also assume a baseline receiver which is not capable of mitigating external interference. The network can obtain CQI reports under certain radio conditions and determine the receiver type of the wireless terminal 22 as follows:

IF [CQI_{Report} > (CQI_{Ref} + X1 dB) AND CQI_{Report} < (CQI_{Ref} + X2 dB)]

THEN assume that wireless terminal 22 supports enhanced receiver
type A

ELSE IF [CQI_{Report} ≧ (CQI_{Ref} + X2 dB)]

THEN assume that wireless terminal 22 supports enhanced receiver
type B

ELSE

assume wireless terminal 22 supports a baseline receiver.

Here, X1 and X2 (X2>X1) are thresholds corresponding to CQI. In one or more embodiments, X2 and X1 differ by 3 dB or more.

The wireless terminal 22 receiver type can also be determined using another quality performance metric, e.g. Block Error Rate (BLER) based on HARQ performance for a given transport format of data block on downlink channel. The HARQ BLER is estimated at the network based on received ACK/NACK from the wireless terminal 22. The reference BLER (BLER_{Ref}) is determined based on a reference transport format for a wireless terminal 22 with a baseline receiver. Assuming the same SNR, the wireless terminal 22 receiver type can be determined as follows:

IF [BLERₑₛₜ < (BLER_{Ref} + Y1)]

THEN assume wireless terminal 22 supports enhanced receiver type
B

ELSE IF [BLERₑₛₜ < (BLER_{Ref} + Y2 dB) AND BLERₑₛₜ ≧ (BLER_{Ref} +
Y1)]

THEN assume wireless terminal 22 supports enhanced receiver type
A

ELSE

assume wireless terminal 22 supports a baseline receiver.

Here, Y1 and Y2 (Y1<Y2) are thresholds corresponding to HARQ BLER in percentage. In one or more embodiments, Y1 is 10 times or more lower than Y2.

The reliability of the determination of the receiver type can be further improved by using multiple performance metrics, e.g., CQI and BLER based on HARQ performance. For example, in one or more embodiments a particular receiver type is selected by the node performing method 100 provided conditions related to both CQI and BLER mentioned above are met. Otherwise the node assumes that the wireless terminal 22 has a baseline receiver (i.e., lacks multiple receive antennas, and cannot mitigate external interference caused by a neighbor cell).

Combined Implicit and Explicit Mechanism

In a combined mechanism the network node performing method 100 uses a combination of explicit indication and implicit determinations to determine the type of receiver supported by a wireless terminal 22. For example, it is typically predetermined that a wireless terminal 22 which supports certain high end feature such as Multiple Input Multiple Output (MIMO), multi-carrier, higher order modulation (e.g., 64 Quadrature Amplitude Modulation “QAM”), etc., meets the requirements corresponding to certain advanced or enhanced receiver types. The corresponding wireless terminal 22 enhanced requirements are also predefined for the wireless terminal 22 which supports that specific feature. For example, assume it is predefined that the wireless terminal 22 supporting MIMO shall meet enhanced requirements corresponding to receiver type 1, type 2, and type 3, where type 3 requirements corresponds to a most advanced or robust receiver. In this example, the network node implementing method 100 determines the wireless terminal 22 capability in terms of its supported feature(s) (e.g., MIMO) by using an explicit Indication sent by the wireless terminal 22. Then, the network node uses one or more of the explicit mechanisms discussed above to determine the receiver(s) supported by the wireless terminal 22.

Determination of Maximum Rated Output Power of LPN

As shown in blocks 202, 302 of FIGS. 2-3, in some embodiments the network node implementing method 100 determines the maximum rated output power P_{MAX} of the LPN 14. The maximum rated output power of a radio network node is predefined or is declared by a manufacturer. The 3GPP TS 25.104 standard, section 6.2.1, defines the maximum rated output power of various classes of base stations (BSs), as shown in Table 1 below. In one or more embodiments, the P_{MAX} of the LPN 14 is the mean power level per carrier measured at the antenna connector in specified reference condition. The rated output power (P_{RAT}) of the BS is expressed in Table 1 below.

TABLE 1
Base Station rated output power

| BS class | PRAT |
|---|---|
| Wide Area BS | — (note) |
| Medium Range BS | ≦+38 dBm |
| Local Area BS | ≦+24 dBm |
| Home BS | ≦+20 dBm (without transmit |
| | diversity or MIMO) |
| | ≦+17 dBm (with transmit |
| | diversity or MIMO) |

NOTE:
There is no upper limit required for the rated output power of the Wide Area Base Station like for the base station for General Purpose application in Release 99, 4, and 5.

A wide area BS serves a macro cell. A medium range BS serves a micro cell. A local area BS serves a pico cell, whereas a home BS serves a femto cell. Typically a wide area BS is regarded as a HPN 18, whereas al the remaining ones can be regarded as LPNs 14. The above mentioned information for one or more neighboring network nodes can be acquired by the network based on pre-determined knowledge of the deployed BS types in the coverage area, e.g., stored in a Radio Network Controller (RNC), eNodeB, etc. The network node implementing method 100 can also acquire this information from another network node e.g., Self-Organizing Network (SON), Operation & Maintenance (O&M), Operational Support System (OSS), etc., which is aware of the deployment scenario in terms of different types of base stations in a coverage area. Alternatively each radio network node may also report its maximum rated output power capability to the network node implementing method 100, which can then use this information together with some other data to make a cell change decision.

The threshold to compare the maximum output power to is typically expressed in dBm. The medium range BS maximum output power can range from 24 dBm to 38 dBm according to Table 1. For example, a threshold for comparing the maximum output power of an LPN comprising a medium range base station can be set to 30 dBm. In one or more embodiments the threshold is selected to ensure that continuity of coverage is maintained when changing cells. In this example a particular action such as the cell change of the wireless terminal 22 from the first cell 12 to the second cell 16 can be delayed provided the LPN 14 serving the first cell 12 have a maximum rated output power that is greater than 30 dBm.

Determining LPN Receiver Type

The network node performing method 100 acquires information related to the receiver type capability of one or more neighboring LPNs 14 (e.g., a neighbor to a HPN 18). For example, a determination may be made of whether the LPN 14 receiver is capable of mitigating at least the interference caused by wireless terminals 22 served by neighboring cells. The above mentioned information for one or more neighboring network nodes can be acquired based on predetermined knowledge of the receiver types used in the deployed BS types in the coverage area. This information could also be acquired from another network node, e.g., SON, O&M, OSS, etc., which is aware of the supported receiver type or receiver capability information of the radio network nodes deployed in the coverage area. The network node implementing method 100 maintains the predetermined or acquired receiver type information as shown as an example in Table 2. The receiver type information may also contain more comprehensive information, such as a number of receive antennas, physical channels whose interference can be mitigated, etc. The table can also be updated if there is any change. In one or more embodiments, the network node implementing method 100 uses this information with other data to make cell change decisions and/or to configure a mobility parameter.

TABLE 2
Receiver type capability of neighboring base stations

| | | Capable of mitigating non-serving |
|---|---|---|
| BS ID | BS type/class | wireless terminal interference |
| 1 | LPN | 0 |
| 2 | LPN | 1 |
| 3 | LPN | 1 |
| 4 | HPN | 1 |
| . . . | . . . | 0 |
| N | LPN | 0 |

In one or more embodiments, to determine LPN 14 receiver type, a radio measurement from the LPN 14 is compared to one or more of:
a radio measurement from an additional LPN that is known to not have a type of receiver that can mitigate external interference and to not have multiple receive antennas; and
a reference radio measurement value corresponding to a radio measurement performed by an additional LPN which does not have a type of receiver that can mitigate external interference and does not have multiple receive antennas.

If the comparing indicates that the LPN 14 is subject to less external interference than the additional LPN, it is determined that the LPN 14 has a type of receiver that can mitigate external interference, has multiple receive antennas, or both.

Determining HPN Receiver Type

In one or more embodiments, to determine the HPN 18 receiver type, the network node implementing method 100 compares comparing a radio measurement from the HPN 18 to one or more of:
a radio measurement from an additional HPN that is known to not have a type of receiver that can mitigate external interference and to not have multiple receive antennas; and
a reference radio measurement value corresponding to a radio measurement performed by an additional HPN which does not have a type of receiver that can mitigate external interference and does not have multiple receive antennas.

If the comparing indicates that the HPN 18 is subject to less external interference than the additional HPN, It is determined that the HPN 18 has a type of receiver that can mitigate external interference, has multiple receive antennas, or both.

Delaying a Cell Change

As discussed above, delaying a cell change (block 104) may Include delaying transmission of a cell change command to the wireless terminal 22 by at least a defined delay time relative to a time at which a measurement report is received from the wireless terminal 22 (block 106).

In one or more embodiments, for a cell change from the first cell 12 served by HPN 14 to the second cell 16 served by HPN 18, the network node implementing the method 100 obtains the “defined delay time” as a function of one or more of:
the maximum rated output power of the LPN 14;
a degree to which the wireless terminal 22 is able to mitigate external interference caused by signals received from at least one neighbor cell of the serving cell; and
a radio measurement from the wireless terminal.

As discussed above, in one or more embodiments, the predefined conditions include the HPN 18 having a type of receiver that can mitigate external interference and/or the HPN 18 having multiple receive antennas. In one or more of such embodiments, the defined delay time is also be a function of one or more of:
a radio measurement from the HPN 18; and
a degree to which the HPN 18 is able to mitigate external interference caused by signals received from at least one wireless terminal not served by the HPN 18.

In one or more embodiments, for a cell change from the second cell 16 served by HPN 18 to the first cell 12 served by LPN 14, the network node implementing the method 100 obtains the defined delay time as a function of one or more of:
a receive antenna quantity of the wireless terminal 22;
a receive antenna quantity of the LPN 14;
a degree to which the wireless terminal 22 is able to mitigate external interference caused by signals received from at least one neighbor cell of the second cell 16; and
a degree to which the LPN 14 is able to mitigate external interference caused by signals received from at least one wireless terminal not served by the LPN 14.

The receive antenna quantity herein more specifically means number of receive antennas at the wireless terminal 22 or at the LPN 14.

The cell change being delayed can be one of handover, cell reselection, Radio Resource Control (RRC) connection release with redirection, RRC connection re-establishment, primary serving cell or primary cell change in multicarrier operation, primary component carrier (PCC) change in multicarrier operation, and primary cell or radio link change in multipoint or coordinated multipoint transmission and reception (CoMP) operation, for example.

Delaying the cell change will either cause the wireless terminal 22 to delay changing cells from the first cell 12 to the second cell 16, or to delay changing cells from the second cell 16 to the first cell 12. This will cause the wireless terminal 22 to remain supported by the LPN 14 for longer, or to remain supported by the HPN 18 for longer.

Generally it is desirable to avoid burdening the HPN 18 if possible. Keeping the wireless terminal 22 supported by the LPN 14 achieves this, and this is acceptable because the predefined conditions in such embodiments (e.g., FIGS. 3-3a) indicate that that the LPN 14, wireless terminal 22, or both can acceptably allow the wireless terminal 22 to remain in the first cell 12 for a longer time when the wireless terminal 22 is moving away from the LPN 14. For example, if the LPN 14 has a maximum rated output power that exceeds a predefined threshold, more geographical area will be covered by the LPN 14 at a greater distance away from the LPN 14. Thus, a wireless terminal 22 moving away from the LPN 14 does not need to change cells as quickly. Similarly, if the wireless terminal 22 has multiple receive antennas and/or a type of receiver that can mitigate external interference caused by signals received from neighbor cells, then the wireless terminal 22 can tolerate a diminished signal-to-interference ratio (SIR) as signal power reduces when the wireless terminal 22 moves away from the LPN 14. Here, as above, the wireless terminal 22 can remain supported by the LPN 14 for a longer period of time. Delaying a cell change in this regard can advantageously offload the HPN 18 while avoiding unnecessarily premature cell changes (rendered unnecessary by the predefined conditions).

Regarding a delayed cell change from the second cell 16 served by HPN 18 to the first cell 12 served by LPN 14, the cell change delay keeps the wireless terminal 22 in the second cell 16 longer. Here, the predefined conditions indicate either that the wireless terminal 22 is capable of mitigating external interference, or that the LPN 14 is capable of mitigating external Interference (see, e.g., FIG. 4). Although a cell change delay in this example does not offload the HPN 18 as quickly, avoiding a premature and/or unnecessary handover to the first cell 12 served by LPN 14 is desirable for high-speed users. Moreover, for either LPN-to-HPN cell changes, or HPN-to-LPN cell changes, if the predefined conditions are true then the network node implementing method 100 knows that a cell change can be acceptably delayed, and this can advantageously be used to alleviate or at least reduce a number of cell changes (or “ping pongs”) between the cells 12, 16.

As discussed above, in some embodiments delaying the cell change comprises configuring the wireless terminal 22 with at least one mobility parameter to cause a delay at the wireless terminal 22 in transmitting a measurement report relative to a time at which the wireless terminal 22 would have transmitted the measurement report without being configured with the at least one mobility parameter. In one or more of such embodiments, configuring the wireless terminal 22 with at least one mobility parameter comprises configuring the wireless terminal 22 with a new mobility parameter value (e.g., to configure a new mobility parameter for the first time, or to replace or reconfigure an existing mobility parameter value stored in the wireless terminal 22). In some embodiments, the parameter comprises at least one of: a signal time averaging parameter value used by the wireless terminal in determining when to transmit a measurement report, and a signal hysteresis parameter used by the wireless terminal in determining when to transmit a measurement report.

Example signal time averaging parameters include a time to trigger (TTT), higher layer time domain filtering coefficient (e.g., a layer 3 filtering coefficient), etc. The TTT, for example, represents an amount of time that a given condition must be true before a wireless terminal 22 transmits a measurement report (e.g., event-triggered report or periodic event-triggered report). An example of higher layer time domain filter (i.e., layer 3 filtering) implemented in the wireless terminal is expressed by the following expression:

Fₙ=(1−a)·Fₙ₋₁+a·Mₙ where
Mₙ is a latest received measurement result from the physical layer;
Fₙ is an updated filtered measurement result, that is used for evaluation of reporting criteria or for measurement reporting;
Fₙ₋₁ is an old filtered measurement result, where F₀ is set to M₁ when the first measurement result from the physical layer is received; and
a=½^{(k/4)}, where k is a layer 3 filtering coefficient configured at the wireless terminal 22 by the network node implementing method 100 for applying filtering to the corresponding measurement results (k=4 is typically a default value, and k=0 means no layer 3 filtering).

An example signal hysteresis parameter includes a value used to indicate a magnitude beyond a threshold that a given value must reach before a measurement report is transmitted (e.g., how high a given value must be during the TTT). In one or more embodiments, the signal hysteresis parameter is indicative of one or more of a cell change margin, a cell reselection margin, and a handover margin. These parameters are configured at the wireless terminal 22 (e.g., by a RNC) using higher layer signaling protocol (e.g., RRC protocol signaling).

By configuring the wireless terminal 22 with a new mobility parameter that causes a delay of the transmission of measurement reports from the wireless terminal 22, a cell change that would otherwise be triggered by an earlier-received copy of the measurement report can be effectively delayed.

The methods described above can advantageously reduce the serving cell change failure rate for LPN-to-HPN and HPN-to-LPN cell changes, and correspondingly decrease the number of cell change and/or mobility related procedures in the network 10. The downlink (DL) reception quality of a signal at the receiver of the wireless terminal 22 under consideration can be improved, and the uplink (UL) reception quality of a signal at the receiver of LPN 14 can also be improved. Moreover, in some embodiments, load balancing of users in the network 10 can be improved by offloading the HPN 18. Overall signaling overhead, delays and interruption can also be reduced, due to the reduction in cell changes.

Example Applications

In one example, the first cell 12 is a pico cell and the second cell 16 is a macro cell, and the wireless terminal 22 is moving from the pico cell served by a LPN 14 to the macro cell served by the HPN 18. As a first step, the network node implementing method 100 determines the wireless terminal 22 receiver type using the explicit, implicit, and/or combined detection mechanism described above. The node then determines the maximum rated output power of the serving LPN 14 using, e.g., the base station rated output power Table 1. Subsequently, the node selectively delays the cell change of the wireless terminal 22 depending upon the wireless terminal 22 receiver type and/or maximum rated output power of the serving pico cell (P_{MAX} of LPN 14). If the wireless terminal 22 receiver has a receiver capable of mitigating external interference, and/or the maximum rated output power of the LPN 14 is above a threshold, then a cell change of the wireless terminal from the pico cell to the macro cell is delayed. Advantageously, the wireless terminal 22 experiences better user performance since it is connected to the LPN 14, the HPN 18 can be offloaded, and number of unnecessary cell changes is reduced. Optionally, the network node implementing method 100 optionally informs other network nodes (e.g., neighboring base stations, RNC, eNB, etc.) that the cell change of this particular wireless terminal 22 has been delayed. Consequently, the LPN 14 and/or wireless terminal 22 may activate their “enhanced receiver” features to enable external interference mitigation for wireless terminals 22 in non-serving cells.

In another scenario similar to the one described above, the wireless terminal 22 is moving from a pico cell served by a LPN 14 to a macro cell served by a HPN 18. The network node implementing method 100 detects the wireless terminal 22 receiver type to be a baseline receiver which is not capable of mitigating external interference as an advanced or enhanced receiver could do. However, the maximum rated output power of serving LPN (P_{MAX}) was found to be above the threshold. In this case, the cell change is selectively delayed, based on the understanding that P_{MAX} causes the LPN 14 to support a larger geographical area than LPNs having a lower maximum rated output power, and that a cell change can therefore be delayed.

In yet another example, a wireless terminal 22 is moving from the second cell 16 (e.g., a macro cell) to the cell 12 (e.g., a pico cell). The network node implementing method 100 initially determines the wireless terminal 22 receiver to be of advanced or enhanced type capable of interference mitigation, using one of the detection mechanisms discussed above (e.g., explicit, implicit, or combined). The node then determines the LPN 14 receiver type. Based on the wireless terminal 22 including a receiver capable of mitigating external interference, a cell change of the wireless terminal 22 is delayed by configuring at the wireless terminal 22 a larger value of a TTT parameter and/or a larger value of comparative signal hysteresis parameter (e.g., cell reselection signal margin or handover margin). An advantage of this procedure is that the so called ping-pong effect (frequent unnecessary cell change) is reduced, and thus also the probability of cell change failure is reduced. Since the wireless terminal 22 receiver is capable of interference mitigation it may be able to cope with a sudden increase in interference level from the aggressor cell (pico). Finally, the wireless terminal 22 is optionally informed that its cell change has been selectively delayed. Consequently, the wireless terminal 22 may activate its advanced or enhanced receiver to mitigate external interference caused by neighbor cells. The network node implementing method 100 may also send information about 1 or 2 strongest aggressors to help the wireless terminal 22 to more effectively mitigate the interference caused by these nodes.

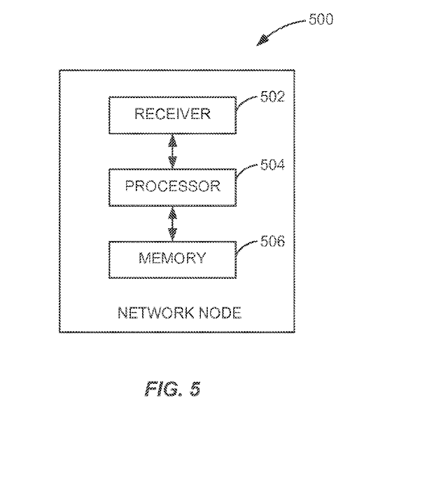

FIG. 5 schematically illustrates an example network node 500 operative to implement the method 100. Thus, the network node 500 may be the LPN 14, HPN 18, or network node 20. The network node 500 includes a receiver 502, processor 504, and memory 506. The processor 504 comprises one or more processing circuits, including, for example, one or more microprocessors, microcontrollers, digital signal processors, or the like. Using the receiver 502 and memory 506, the processor 504 is configured to carry out one or more of the techniques discussed above.

Thus, in one or more embodiments the network node 500 is operative to delay a cell change of the wireless terminal 22 from the first cell 12 served by the LPN 14 to the second cell 16 served by the HPN 18, wherein the LPN 14 has a lower output power than the HPN 18. The one or more processing circuits are configured to delay the cell change of the wireless terminal 22 when at least one of one or more predefined conditions are met. The one or more predefined conditions comprising one or more of
the LPN 14 having a maximum rated output power that exceeds a predefined threshold;
the wireless terminal 22 having a type of receiver that can mitigate at least external interference caused by signals received from at least one neighbor cell of the first cell 12; and
the wireless terminal 22 having multiple receive antennas;

To delay the cell change of the wireless terminal 22, the one or more processing circuits are configured to:
delay transmission of a cell change command to the wireless terminal 22 by at least a defined delay time relative to a time at which a measurement report is received from the wireless terminal 22; and/or
configure the wireless terminal 22 with at least one mobility parameter to cause a delay at the wireless terminal 22 in transmitting a measurement report relative to a time at which the wireless terminal 22 would have transmitted the measurement report without being configured with the at least one mobility parameter.

In one or more embodiments, the network node 500 is operative to delay a cell change of the wireless terminal 22 from the second cell 16 served by HPN 18 to a first cell 12 served by LPN 14, wherein the HPN 18 has a higher output power than the LPN 14. The one or more processing circuits are configured to delay the cell change of the wireless terminal 22 when at least one of one or more predefined conditions are met, the one or more predefined conditions comprising one or more of
the wireless terminal 22 having a type of receiver that can mitigate at least external interference caused by signals received from at least one neighbor cell of the second cell 16, having multiple receive antennas, or both; and
the LPN 14 having a type of receiver that can mitigate at least external interference caused by signals received from at least one wireless terminal not served by the LPN 14, having multiple receive antennas, or both;

To delay the cell change of the wireless terminal 22, the one or more processing circuits are configured to:
delay transmission of a cell change command to the wireless terminal 22 by at least a defined delay time relative to a time at which a measurement report is received from the wireless terminal 22; and/or
configure the wireless terminal 22 with at least one mobility parameter to cause a delay at the wireless terminal 22 in transmitting a measurement report relative to a time at which the wireless terminal 22 would have transmitted the measurement report without being configured with the at least one mobility parameter.

Although a two-tiered HetNet has been illustrated and discussed, including a single LPN 14 and single HPN 18, it is understood that multiple tiers could be used. For example, in one or more embodiments three base stations are included: a eNodeB, a base station supporting a microcell (BS-MC) and a base station supporting a pico cell (BS-PC). In this embodiment the eNodeB is considered a HPN, and the BS-PC is considered a LPN—but the BS-MC may be either a LPN or a HPN. That is, with respect to the eNodeB the BS-MC is a LPN, but with respect to the BS-PC it is an HPN. Thus, the techniques described above may be applied to a multi-tiered network by being applied to the BS-MC as a LPN, a HPN, or both.

Although LTE networks have been discussed to some degree, it is understood that this is only a non-limiting example, and it is understood that the methods and apparatus described above could apply to other HetNet technologies such Universal Terrestrial Radio Access Network (UTRAN) Frequency Division Duplex (FDD), or UTRAN Time Division Duplex (TDD). Other possible technologies include Global System for Mobile Communication (GSM), GSM Enhanced Data Rates for GSM Evolution (EDGE) Radio Access Networks (GERAN), Wideband Code Division Multiple Access (WCDMA), CDMA2000, High Speed Packet Access (HSPA), etc. The techniques described above are also applicable to any node which employs multi-RAT such as a multi-standard radio (MSR) node or base stations.

Thus, the foregoing description and the accompanying drawings represent non-limiting examples of the methods and apparatus taught herein. As such, the present Invention is not limited by the foregoing description and accompanying drawings. Instead, the present invention is limited only by the following claims and their legal equivalents.

1-32. (canceled)

33. A method, implemented by a network node, for controlling a cell change of a wireless terminal from a first cell served by a low power node to a second cell served by a high power node, wherein the low power node has a lower output power than the high power node, the method comprising:
delaying the cell change of the wireless terminal when at least one of one or more predefined conditions are met, the one or more predefined conditions comprising one or more of:
the low power node having a maximum rated output power that exceeds a predefined threshold;
the wireless terminal having a type of receiver that can mitigate at least external interference caused by signals received from at least one neighbor cell of the first cell; and
the wireless terminal having multiple receive antennas;
wherein the delaying comprises one or more of:
delaying transmission of a cell change command to the wireless terminal by at least a defined delay time relative to a time at which a measurement report is received from the wireless terminal; and
configuring the wireless terminal with at least one mobility parameter to cause a delay at the wireless terminal in transmitting a measurement report relative to a time at which the wireless terminal would have transmitted the measurement report without being configured with the at least one mobility parameter.

34. The method of claim 33, further comprising obtaining the defined delay time as a function of one or more of:
the maximum rated output power of the low power node;
a degree to which the wireless terminal is able to mitigate external interference caused by signals received from at least one neighbor cell of the first cell; and
a radio measurement from the wireless terminal.

35. The method of claim 33, wherein the one or more predefined conditions further comprise:
the high power node having a type of receiver that can mitigate at least external interference caused by signals received from at least one wireless terminal not served by the high power node; and
the high power node having multiple receive antennas.

36. The method of claim 35, further comprising obtaining a defined delay time as a function of one or more of:
a radio measurement from the high power node; and
a degree to which the high power node is able to mitigate external interference caused by signals received from at least one wireless terminal not served by the high power node.

37. The method of claim 35, further comprising:
comparing a radio measurement from the high power node to one or more of:
a radio measurement from an additional high power node that is known to not have a type of receiver that can mitigate external interference and to not have multiple receive antennas; and
a reference radio measurement value corresponding to a radio measurement from an additional high power node which does not have a type of receiver that can mitigate external interference and does not have multiple receive antennas; and
if the comparing indicates that the high power node is subject to less external interference than the additional high power node, determining that the high power node has a type of receiver that can mitigate external interference, has multiple receive antennas, or both.

38. A method, implemented by a network node, for controlling a cell change of a wireless terminal from a second cell served by a high power node to a first cell served by a low power node, wherein the high power node has a higher output power than the low power node, the method comprising:
delaying the cell change of the wireless terminal when at least one of one or more predefined conditions are met, the one or more predefined conditions comprising one or more of:
the wireless terminal having a type of receiver that can mitigate at least external interference caused by signals received from at least one neighbor cell of the second cell, having multiple receive antennas, or both; and
the low power node having a type of receiver that can mitigate at least external interference caused by signals received from at least one wireless terminal not served by the low power node, having multiple receive antennas, or both;
wherein the delaying comprises one or more of:
delaying transmission of a cell change command to the wireless terminal by at least a defined delay time relative to a time at which a measurement report is received from the wireless terminal; and
configuring the wireless terminal with at least one mobility parameter to cause a delay at the wireless terminal in transmitting a measurement report relative to a time at which the wireless terminal would have transmitted the measurement report without being configured with the at least one mobility parameter.

39. The method of claim 38, further comprising obtaining the defined delay time as a function of one or more of:
a receive antenna quantity of the wireless terminal;
a receive antenna quantity of the low power node;
a degree to which the wireless terminal is able to mitigate external interference caused by signals received from at least one neighbor cell of the second cell; and
a degree to which the low power node is able to mitigate external interference caused by signals received from at least one wireless terminal not served by the low power node.

40. The method of claim 33:
wherein the one or more predefined conditions include the low power node having a type of receiver that can mitigate at least external interference caused by signals received from at least one wireless terminal not served by the low power node, having multiple receive antennas, or both;
the method further comprising:
comparing a radio measurement from the low power node to one or more of:
a radio measurement from an additional low power node that is known to not have a type of receiver that can mitigate external interference and to not have multiple receive antennas; and
a reference radio measurement value corresponding to a radio measurement from an additional low power node which does not have a type of receiver that can mitigate external interference and does not have multiple receive antennas; and
if the comparing indicates that the low power node is subject to less external interference than the additional low power node, determining that the low power node has a type of receiver that can mitigate external interference, has multiple receive antennas, or both.

41. The method of claim 33:
wherein configuring the wireless terminal with at least one mobility parameter comprises configuring the wireless terminal with a new mobility parameter value; and
wherein the new mobility parameter value comprises at least one of:
a signal time averaging parameter value used by the wireless terminal in determining when to transmit a measurement report; and
a signal hysteresis parameter value used by the wireless terminal in determining when to transmit a measurement report.

42. The method of claim 41:
wherein the signal time averaging parameter value is indicative of one or more of a layer 3 filtering coefficient and a time to trigger; and
wherein the signal hysteresis parameter value is indicative of one or more of a cell change margin, a cell reselection margin, and a handover margin.

43. The method of claim 33:
wherein the one or more predefined conditions include the wireless terminal having a type of receiver that can mitigate at least external interference caused by signals received from at least one neighbor cell of the second cell, having multiple receive antennas, or both;
the method further comprising:
comparing a radio measurement from the wireless terminal to one or more of:
a radio measurement from an additional wireless terminal that is known to not have a type of receiver that can mitigate external interference and to not have multiple receive antennas;
a reference radio measurement value representing a radio measurement from an additional wireless terminal which does not have a type of receiver that can mitigate external interference and does not have multiple receive antennas; and
if the comparing indicates that the wireless terminal is subject to less external interference than the additional wireless terminal, determining that the wireless terminal has a type of receiver that can mitigate external interference, has multiple receive antennas, or both.

44. The method of claim 43, wherein the compared radio measurements are downlink radio measurements.

45. The method of claim 33, further comprising transmitting a notification to the wireless terminal, to another network node, or both, indicating that the cell change of the wireless terminal has been delayed.

46. The method of claim 33, wherein the cell change is one of: handover, cell reselection, Radio Resource Control (RRC) connection release with redirection, RRC connection re-establishment, primary serving cell or primary cell change in multicarrier operation, primary component carrier (PCC) change in multicarrier operation, and primary cell or radio link change in multipoint or coordinated multipoint transmission and reception (CoMP) operation.

47. The method of claim 33, wherein the type of receiver that can mitigate external interference is one of:
a Minimum Mean Square Error Interference Rejection (MMSE-IRC) receiver; and
a MMSE-turbo Interference Cancellation (IC) receiver.

48. The method of claim 33:
wherein the low power node is one of a home base station, a local area base station, and a medium base station;
wherein the high power node is a wide area base station;
wherein first cell is one of a femto cell, a pico cell, and a micro cell; and
wherein second cell is a macro cell.

49. A network node operative to delay a cell change of a wireless terminal from a first cell served by a low power node to a second cell served by a high power node, wherein the low power node has a lower output power than the high power node, the network node comprising:
one or more processing circuits configured to:
delay the cell change of the wireless terminal when at least one of one or more predefined conditions are met, the one or more predefined conditions comprising one or more of:
the low power node having a maximum rated output power that exceeds a predefined threshold;
the wireless terminal having a type of receiver that can mitigate at least external interference caused by signals received from at least one neighbor cell of the first cell; and
the wireless terminal having multiple receive antennas;
wherein to delay the cell change of the wireless terminal, the one or more processing circuits are configured to:
delay transmission of a cell change command to the wireless terminal by at least a defined delay time relative to a time at which a measurement report is received from the wireless terminal; and/or
configure the wireless terminal with at least one mobility parameter to cause a delay at the wireless terminal in transmitting a measurement report relative to a time at which the wireless terminal would have transmitted the measurement report without being configured with the at least one mobility parameter.

50. The network node of claim 49, wherein the one or more processing circuits are configured to obtain the defined delay time as a function of one or more of:
the maximum rated output power of the low power node;
a degree to which the wireless terminal is able to mitigate external interference caused by signals received from at least one neighbor cell of the first cell; and
a radio measurement from the wireless terminal.

51. The network node of claim 49, wherein the one or more predefined conditions further comprise:
the high power node having a type of receiver that can mitigate at least external interference caused by signals received from at least one wireless terminal not served by the high power node; and
the high power node having multiple receive antennas.

52. The network node of claim 51, wherein the one or more processing circuits are configured to obtain a defined delay time as a function of one or more of:
a radio measurement from the high power node; and
a degree to which the high power node is able to mitigate external interference caused by signals received from at least one wireless terminal not served by the high power node.

53. The network node claim 51, wherein the one or more processing circuits are configured to:
compare a radio measurement from the high power node to one or more of:
a radio measurement from an additional high power node that is known to not have a type of receiver that can mitigate external interference and to not have multiple receive antennas; and
a reference radio measurement value corresponding to a radio measurement from an additional high power node which does not have a type of receiver that can mitigate external interference and does not have multiple receive antennas; and
if the comparison indicates that the high power node is subject to less external interference than the additional high power node, determine that the high power node has a type of receiver that can mitigate external interference, has multiple receive antennas, or both.

54. A network node operative to delay a cell change of a wireless terminal from a second cell served by a high power node to a first cell served by a low power node, wherein the high power node has a higher output power than the low power node, the network node characterized by:
one or more processing circuits configured to:
delay the cell change of the wireless terminal when at least one of one or more predefined conditions are met, the one or more predefined conditions comprising one or more of:
the wireless terminal having a type of receiver that can mitigate at least external interference caused by signals received from at least one neighbor cell of the second cell, having multiple receive antennas, or both; and
the low power node having a type of receiver that can mitigate at least external interference caused by signals received from at least one wireless terminal not served by the low power node, having multiple receive antennas, or both;
wherein to delay the cell change of the wireless terminal, the one or more processing circuits are configured to:
delay transmission of a cell change command to the wireless terminal by at least a defined delay time relative to a time at which a measurement report is received from the wireless terminal; and/or
configure the wireless terminal with at least one mobility parameter to cause a delay at the wireless terminal in transmitting a measurement report relative to a time at which the wireless terminal would have transmitted the measurement report without being configured with the at least one mobility parameter.

55. The network node of claim 54, wherein the one or more processing circuits are configured to obtain the defined delay time as a function of one or more of:
a receive antenna quantity of the wireless terminal;
a receive antenna quantity of the low power node;
a degree to which the wireless terminal is able to mitigate external interference caused by signals received from at least one neighbor cell of the second cell; and
a degree to which the low power node is able to mitigate external interference caused by signals received from at least one wireless terminal not served by the low power node.

56. The network node of claim 49:
wherein the one or more predefined conditions include the low power node having a type of receiver that can mitigate at least external interference caused by signals received from at least one wireless terminal not served by the low power node, having multiple receive antennas, or both;
wherein the one or more processing circuits are configured to:
compare a radio measurement from the low power node to one or more of:
a radio measurement from an additional low power node that is known to not have a type of receiver that can mitigate external interference and to not have multiple receive antennas; and
a reference radio measurement value corresponding to a radio measurement from an additional low power node which does not have a type of receiver that can mitigate external interference and does not have multiple receive antennas; and
if the comparison indicates that the low power node is subject to less external interference than the additional low power node, determine that the low power node has a type of receiver that can mitigate external interference, has multiple receive antennas, or both.

57. The network node of claim 49:
wherein to configure the wireless terminal with at least one mobility parameter, the one or more processing circuits are configured to configure the wireless terminal with a new mobility parameter value; and
wherein the new mobility parameter value comprises at least one of:
a signal time averaging parameter value used by the wireless terminal in determining when to transmit a measurement report; and
a signal hysteresis parameter value used by the wireless terminal in determining when to transmit a measurement report.

58. The network node of claim 57, wherein:
wherein the signal time averaging parameter value is indicative of one or more of a layer 3 filtering coefficient and a time to trigger; and
wherein the signal hysteresis parameter value is indicative of one or more of a cell change margin, a cell reselection margin, and a handover margin.

59. The network node of claim 49:
wherein the one or more predefined conditions include the wireless terminal having a type of receiver that can mitigate at least external interference caused by signals received from at least one neighbor cell of the second cell, having multiple receive antennas, or both; and
wherein the one or more processing circuits are configured to:
compare a radio measurement from the wireless terminal to one or more of:
a radio measurement from an additional wireless terminal that is known to not have a type of receiver that can mitigate external interference and to not have multiple receive antennas;
a reference radio measurement value representing a radio measurement from an additional wireless terminal which does not have a type of receiver that can mitigate external interference and does not have multiple receive antennas; and
if the comparison indicates that the wireless terminal is subject to less external interference than the additional wireless terminal, determine that the wireless terminal has a type of receiver that can mitigate external interference, has multiple receive antennas, or both.

60. The network node of claim 59, wherein the compared radio measurements are downlink radio measurements.

61. The network node of claim 49, wherein the one or more processing circuits are configured to transmit a notification to the wireless terminal, to another network node, or both, indicating that the cell change of the wireless terminal has been delayed.

62. The network node of claim 49, wherein the cell change is one of: handover, cell reselection, Radio Resource Control (RRC) connection release with redirection, RRC connection re-establishment, primary serving cell or primary cell change in multicarrier operation, primary component carrier (PCC) change in multicarrier operation, and primary cell or radio link change in multipoint or coordinated multipoint transmission and reception (CoMP) operation.

63. The network node of claim 49, wherein the type of receiver that can mitigate external interference is one of:
a Minimum Mean Square Error Interference Rejection (MMSE-IRC) receiver; and
a MMSE-turbo Interference Cancellation (IC) receiver.

64. The network node of claim 49:
wherein the low power node is one of a home base station, a local area base station, and a medium base station;
wherein the high power node is a wide area base station;
wherein first cell is one of femto cell, pico cell, and a micro cell; and
wherein second cell is a macro cell.
